(19) United States
(12) Patent Application Publication
(10) Pub. No.: US 2026/0085778 A1
(43) Pub. Date: Mar. 26, 2026

(54) FLUID HANDLING COUPLINGS

(71) Applicant: Colder Products Company, Roseville, MN (US)

(72) Inventor: Jack T. Stangl, Falcon Heights, MN (US)

(21) Appl. No.: 19/310,189

(22) Filed: Aug. 26, 2025

Related U.S. Application Data
(60) Provisional application No. 63/699,381, filed on Sep. 26, 2024.

(51) Int. Cl. F16L 37/086

(52) U.S. Cl. CPC F16L 37/086

(57) ABSTRACT

Fluid handling couplings can be made to connect and disconnect other members of a fluid handling system. For example, this document describes fluid couplings that are convenient to couple/decouple and that resist disconnection when subjected to rotation and side loading (and/or while pressurized). In some embodiments, the resistance to disconnection is facilitated by a latch mechanism of the female coupling that includes lateral areas that are slightly out of contact with an annular shoulder of the male coupling.

### CROSS-REFERENCE TO RELATED APPLICATIONS

This application claims the benefit of U.S. Provisional Application Ser. No. 63/699,381 filed Sep. 26, 2024. The disclosure of the prior application is considered part of (and is incorporated by reference in) the disclosure of this application.

### TECHNICAL FIELD

This document relates to fluid handling couplings. For example, this document relates to fluid couplings that are convenient to couple/decouple and that resist disconnection when subjected to rotation while pressurized and/or under side loading.

### BACKGROUND

Fluid handling components such as fluid couplings allow fluid communication between two or more components. Some fluid couplings include features that allow male and female components to be quickly connected or disconnected and may include one or more internal valve components that selectively block or allow flow of fluid through the coupling.

### SUMMARY

This document describes fluid handling couplings. For example, this document describes fluid couplings that are convenient to couple/decouple and that resist disconnection when subjected to rotation while pressurized and/or under side loading. In some embodiments, the resistance to disconnection is facilitated by a latch member of the female coupling that includes a nonplanar surface that abuts against an annular shoulder portion of the male coupling.

In one aspect, this disclosure is directed to a female fluid coupling that includes a coupling body defining a central longitudinal axis and an interior space. The female fluid coupling is configured to receive, in a mated configuration, a front-end portion of a male fluid coupling when the front-end portion is inserted through an open front-end of the coupling body that leads to the interior space. The female fluid coupling also includes a latch member movably coupled to the coupling body and comprising an engagement surface configured to engage against the male fluid coupling to releasably retain the male and female fluid couplings in the mated configuration. The latch member is transversely movable relative to the central longitudinal axis between: (i) a latched position and (ii) an unlatched position. The engagement surface may be closer to the central longitudinal axis in the latched position than in the unlatched position. The engagement surface is nonplanar.

Such a female fluid coupling may optionally include one or more of the following features. The engagement surface may include one or more contoured surfaces. The engagement surface may include one or more planar surfaces. The engagement surface may include multiple planar surfaces. An edge profile of the engagement surface may be at least partially arcuate. An edge profile of the engagement surface may be fully arcuate. The latch member may be forcibly biased to the latched position. The latch member may include an upper surface that a user can press to move the latch member from the latched position to the unlatched position. The latch member may define an opening through which the front-end portion of the male fluid coupling extends when the male and female fluid couplings are in the mated configuration. The opening may be an oblong shape. The engagement surface may extend along less than half of a peripheral wall that defines the oblong shape. The engagement surface may extend along a backside of the peripheral wall that defines the oblong shape.

In another aspect, this disclosure is directed to a fluid coupling system that includes a male fluid coupling and a female fluid coupling. The male fluid coupling includes a front-end portion, and an annular shoulder projecting radially outward from the front-end portion and defining a latch groove behind the annular shoulder. The female fluid coupling a coupling body defining a central longitudinal axis and an interior space. The female fluid coupling is configured to receive, in a mated configuration, the front-end portion of the male fluid coupling when the front-end portion is inserted through an open front-end of the coupling body that leads to the interior space. The female fluid coupling also includes a latch member movably coupled to the coupling body and comprising an engagement surface configured to engage within the latch groove and against the annular shoulder of the male fluid coupling to releasably retain the male and female fluid couplings in the mated configuration. The latch member is transversely movable relative to the central longitudinal axis between: (i) a latched position and (ii) an unlatched position. The engagement surface is closer to the central longitudinal axis in the latched position than in the unlatched position. The engagement surface is nonplanar.

Such a fluid coupling system may optionally include one or more of the following features. the engagement surface comprises one or more contoured surfaces. The engagement surface may include one or more planar surfaces. The engagement surface may include multiple planar surfaces. An edge profile of the engagement surface may be at least partially arcuate. An edge profile of the engagement surface may be fully arcuate. The latch member may be forcibly biased to the latched position. The latch member may define an opening through which the front-end portion of the male fluid coupling extends when the male and female fluid couplings are in the mated configuration. The opening may be an oblong shape. The engagement surface may extend along less than half of a peripheral wall that defines the oblong shape. The engagement surface may extend along a backside of the peripheral wall that defines the oblong shape.

Some embodiments of the devices, systems and techniques described herein may provide one or more of the following advantages. First, the fluid couplings described herein are convenient to couple together. For example, the male coupling may simply be pushed into engagement with the female coupling and the two will be automatically locked together. Second, the fluid couplings described herein are convenient to decouple from each other. For example, a latch component of the female coupling may simply be depressed and the male and female couplings can then be separated from each other. Third, the fluid couplings described herein are designed to provide resistance to disconnection when subjected to rotation while pressurized and/or while subjected to side loading. Fourth, the female couplings described herein are compatible with male couplings in the field. Accordingly, the improved female couplings described herein can be readily adopted in place of many existing female couplings.

The details of one or more implementations are set forth in the accompanying drawings and the description below. Other features and advantages will be apparent from the description and drawings, and from the claims.

### BRIEF DESCRIPTION OF DRAWINGS

The present description is further provided with reference to the appended Figures, wherein like structure is referred to by like numerals throughout the several views, and wherein:

FIG. 1 is a perspective view of an example fluid coupling system that includes an example male fluid coupling and an example female fluid coupling in a disconnected state.

FIG. 2 is a perspective view of an example latch member of the female fluid coupling of FIG. 1.

FIG. 3 is a front view of the latch member of FIG. 2.

FIG. 4 is a side cross-section view of the latch member of FIG. 2 taken along the cut plane 4-4 as shown in FIG. 3.

FIG. 5 is a transverse cross-section view of the latch member of FIG. 2 taken along the cut plane 5-5 as shown in FIG. 3.

FIG. 6 is a front-end view of the female fluid coupling of FIG. 1.

FIG. 7 is a side view of the female fluid coupling of FIG. 1 with a partial cutaway showing a cross-section of the front-end portion in accordance with the cut plane 7-7 shown in FIG. 6.

FIG. 8 is an enlarged view of a portion of FIG. 7 showing the cross-section of the front-end portion of the female fluid coupling.

FIG. 9 is a top view of the fluid coupling system of FIG. 1 in a coupled arrangement.

FIG. 10 is a back-end view of the fluid coupling system of FIG. 9.

FIG. 11 is a partial cross-section view in accordance with the cut plane 11-11 as shown in FIG. 10.

FIG. 12 is a partial cross-section view in accordance with the cut plane 12-12 as shown in FIG. 10.

FIG. 13 is a partial cross-section view in accordance with the cut plane 13-13 as shown in FIG. 10.

FIG. 14 is a longitudinal cross-section view of the male fluid coupling of FIG. 1 in engagement with the latch member of FIG. 2.

FIG. 15 is another longitudinal cross-section view of the male fluid coupling of FIG. 1 in engagement with the latch member of FIG. 2.

### DETAILED DESCRIPTION OF ILLUSTRATIVE EMBODIMENTS

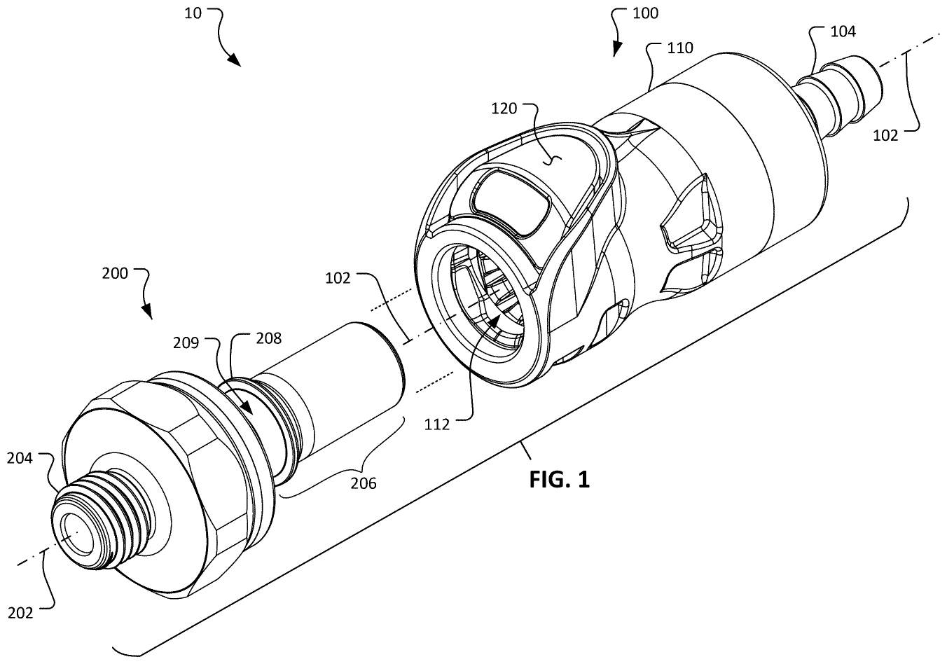

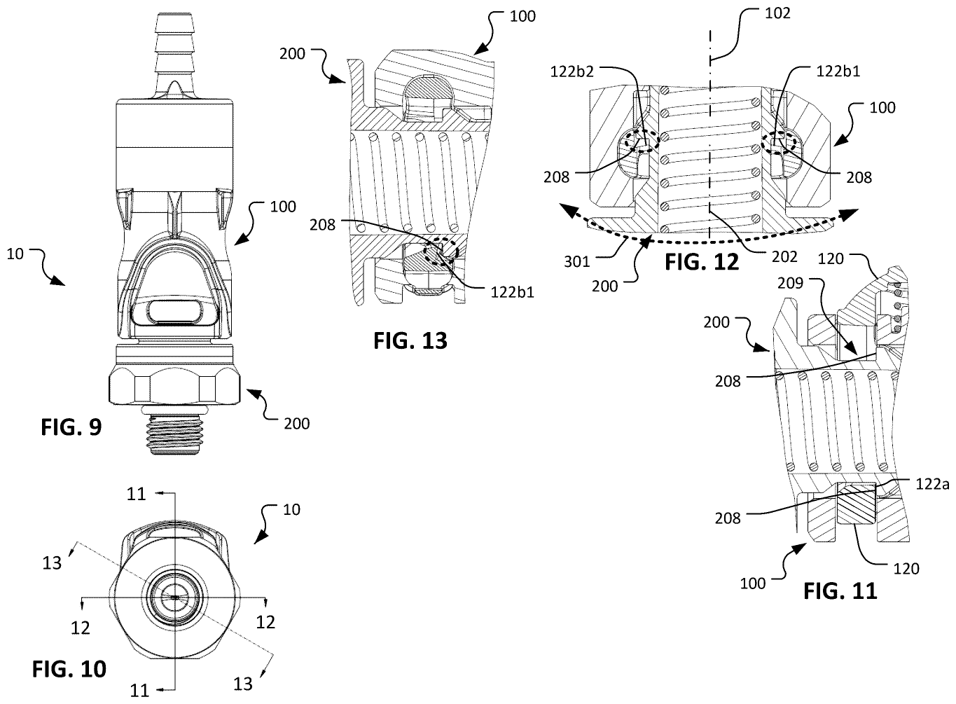

Referring to FIG. 1, a fluid coupling system 10 includes an example female fluid coupling 100 and an example male fluid coupling 200. The male fluid coupling 200 and female fluid coupling 100 can be releasably coupled with each other (e.g., as depicted in FIG. 9-13) to create fluid communication between a female coupling termination 104 and a male coupling termination 204. The female coupling 100 defines a central longitudinal axis 102. The male fluid coupling 200 defines a central longitudinal axis 202.

In the coupled/operative arrangement, the male fluid coupling 200 and female fluid coupling 100 are releasably latched or detained in relation to each other by mechanical interference between a latch member 120 of the female fluid coupling 100 and an annular shoulder 208 of the male fluid coupling 200, as described further below. While in the coupled/latched arrangement, the male fluid coupling 200 and female fluid coupling 100 are rotatable relative to each other about their respective longitudinal axes 102/202. In various embodiments described herein, the latch member 120 is specially designed so that when such relative rotations occur, the mechanically latched/detained arrangement between the male fluid coupling 200 and female fluid coupling 100 remains robust (even when the fluid coupling system 10 is subjected to side loads and/or internal fluid pressure in concurrence with the relative rotation).

The male fluid coupling 200 and female fluid coupling 100 can be uncoupled from each other in response to a user depressing the exposed upper surface of the latch member 120 to move the latch member 120 from its latched position to its unlatched position, as described further below. In some embodiments, when the male fluid coupling 200 and female fluid coupling 100 are uncoupled from each other, valves inside of the male fluid coupling 200 and/or the female fluid coupling 100 close to prevent or mitigate fluid from flowing out of the male fluid coupling 200 and/or the female fluid coupling 100.

While the termination 104 is depicted as a barbed fitting, and the termination 204 is depicted as a threaded fitting, any type of fluid connections can be used. For example, the terminations 104 and/or 204 can be, but not limited to, a compression fitting, a press-in fitting, a luer fitting, a straight threaded fitting or a pipe threaded fitting (internal or external), a sanitary fitting, a pigtail, a T-fitting, a Y-fitting, and any other suitable type of configuration such that the male fluid coupling 200 and female fluid coupling 100 are configured for connection to a fluid system as desired. In some embodiments, the male fluid coupling 200 and/or female fluid coupling 100 may be supplied with a removable cap (not shown), or another type of component, that is releasably coupled with the terminations 104 and/or 204.

The materials from which one or more of the components of the male fluid coupling 200 and/or female fluid coupling 100 are made of include thermoplastics. In particular embodiments, the materials from which the components of the male fluid coupling 200 and/or female fluid coupling 100 are made of are thermoplastics, such as, but not limited to, acetal, polycarbonate, polysulfone, polyether ether ketone, polysulphide, polyester, polyvinylidene fluoride (PVDF), polyethylene, polyphenylsulfone (PPSU; e.g., Radel®), polyetherimide (PEI; e.g., Ultem®), polypropylene, polyphenylene, polyaryletherketone, and the like, and combinations thereof. In some embodiments, the materials from which one or more of the components of the male fluid coupling 200 and/or female fluid coupling 100 are made of include metals such as, but not limited to stainless steel, brass, aluminum, plated steel, and the like.

In particular embodiments, the male fluid coupling 200 and/or female fluid coupling 100 is/are metallic-free. In some embodiments the male fluid coupling 200 and/or female fluid coupling 100 include one or more metallic spring members (e.g., spring steel, stainless steel, and the like) or plastic spring members.

In certain embodiments, male fluid coupling 200 and/or female fluid coupling 100 include one or more seals that are made of materials such as, but not limited to, silicone, fluoroelastomers (FKM), ethylene propylene diene monomer (EPDM), thermoplastic elastomers (TPE), buna, buna-N, thermoplastic vulcanizates (TPV), and the like.

The female fluid coupling 100 includes a coupling body 110 that defines a central longitudinal axis 102 and an interior space 112 for receiving a front-end portion 206 of the male fluid coupling 200 (in order to couple the fluid coupling system 10 together).

The front-end portion 206 of the male fluid coupling 200 includes the annular shoulder 208 that projects radially outward from the rest of the front-end portion 206 to thereby define a latch groove 209 behind the annular shoulder 208. As described further below, a lower portion of the latch member 120 releasably engages within the latch groove 209 and abuts against a backside of the annular shoulder 208 when the female fluid coupling 100 and male fluid coupling 200 are operatively coupled to each other (and the latch member 120 is in its latched position).

As described further below, when the male fluid coupling 200 and female fluid coupling 100 are fully coupled and latched together (e.g., see FIG. 9), the central longitudinal axis 202 of the male fluid coupling 200 and the central longitudinal axis 102 of the female fluid coupling 100 are generally coincident and collinear with each other. However, in some embodiments during the process of coupling the male fluid coupling 200 with the female fluid coupling 100 (e.g., while the front-end portion 206 is being inserted into the interior space 112), the central longitudinal axis 202 of the male fluid coupling 200 and the central longitudinal axis 102 of the female fluid coupling 100 can be spaced apart from each other (i.e., not colinear).

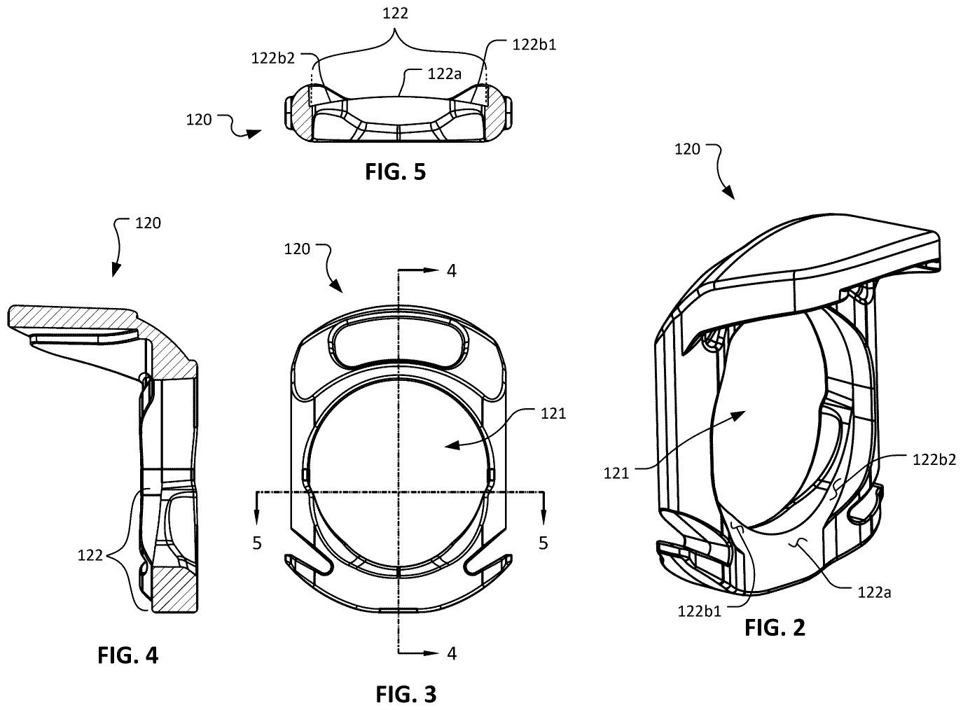

FIG. 2-5 illustrate, in isolation, the latch member 120 of the female fluid coupling 100. The latch member 120 defines an oblong opening 121. The front-end portion 206 of the male fluid coupling 200 passes/extends through the opening 121 when the female fluid coupling 100 and male fluid coupling 200 are operatively coupled/latched to each other.

A lower peripheral portion of the latch member 120 (wherein “lower peripheral portion” refers to the portion below the cut plane 5-5 in FIG. 3) releasably engages within the latch groove 209 of the male fluid coupling 200 (see FIG. 1) when the female fluid coupling 100 and male fluid coupling 200 are operatively coupled/latched to each other. An engagement surface 122 of the latch member 120 extends along a backside of that lower peripheral portion of the latch member 120. The engagement surface 122 is comprised of a lower-most central engagement surface portion 122a and two lateral engagement surface portions 122b1 and 122b2. In the depicted non-limiting embodiment, the length of the periphery of the opening 121 along which the engagement surface 122 extends is less than half of the length of the total periphery of the opening 121 (e.g., as visible in FIG. 3).

At least a portion of the engagement surface 122 abuts against a back side portion of the annular shoulder 208 when the female fluid coupling 100 and male fluid coupling 200 are operatively coupled/latched to each other. That contact (mechanical interference) between the back side portion of the annular shoulder 208 and the engagement surface 122 of the latch member 120 holds the male fluid coupling 200 in operative engagement with the female fluid coupling 100 (by counteracting the longitudinally repulsive forces from the internal fluid pressure within the fluid coupling system 10, and/or from the valve spring(s) of the fluid coupling system 10 when such spring(s) are included).

It can be understood by viewing FIG. 2-5 (especially FIGS. 2, 4, and 5) that the engagement surface 122 is nonplanar. The nonplanar shape of the engagement surface 122 can resist uncoupling of the fluid coupling system 10 when the female fluid coupling 100 and the male fluid coupling 200 are rotated relative to each other (about their longitudinal axes 102/202) in concurrence with side loading of the female fluid coupling 100 and/or the male fluid coupling 200, and/or in concurrence with internal pressurization of the fluid coupling system 10.

In some embodiments, the non-planar engagement surface 122 comprises one or more contoured and/or non-planar surfaces. For example, one or more of the lower-most central engagement surface portion 122a and/or the two lateral engagement surface portions 122b1 and 122b2 can be contoured and/or non-planar. In some embodiments, all three of the lower-most central engagement surface portion 122a and the two lateral engagement surface portions 122b1 and 122b2 are contoured and/or non-planar.

In some embodiments, the engagement surface 122 comprises one or more planar surfaces in addition to one or more contoured surfaces. For example, the lower-most central engagement surface portion 122a can be planar while the two lateral engagement surface portions 122b1 and 122b2 can be contoured and/or non-planar.

In particular embodiments, the engagement surface 122 comprises multiple planar surfaces that are not coplanar with each other. For example, the lower-most central engagement surface portion 122a and the two lateral engagement surface portions 122b1 and 122b2 can each be planar (while being not coplanar with each other).

In some embodiments, the engagement surface 122 comprises a central planar surface (e.g., the lower-most central engagement surface portion 122a) that is orthogonal to the longitudinal axis 102 of the female fluid coupling 100) and two contoured surfaces (the two lateral engagement surface portions 122b1 and 122b2 located on either/both lateral side(s) of the central planar surface).

In some examples of the latch member 120, an edge profile of the engagement surface 122 can be at least partially arcuate (e.g., see FIG. 5). In some embodiments, the edge profile of the engagement surface 122 is fully arcuate (e.g., see FIG. 5).

In the depicted example embodiment of the latch member 120, the two lateral engagement surface portions 122b1 and 122b2 of the engagement surface 122 are both contoured (as seen in FIG. 5) and extend upward non-orthogonally to the longitudinal axis 102 of the female fluid coupling 100 (as seen in FIG. 4).

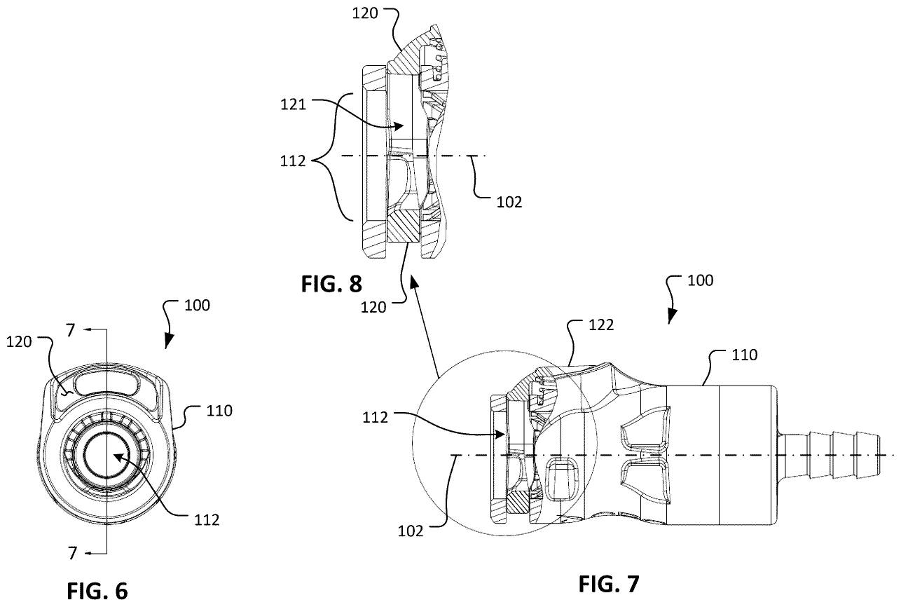

FIG. 6-8 show more detail regarding the arrangement of the latch member 120 relative to the coupling body 110 of the female fluid coupling 100. The latch member 120 is movably coupled to the coupling body 110. For example, as described further below, in the depicted embodiment the latch member 120 is transversely movable relative to the central longitudinal axis 102 of the coupling body 110 between a latched position and an unlatched position. For example, the latch member 120 can be moved to the unlatched position when an upper tab surface 122 of the latch member 120 is manually depressed by a user.

In FIG. 8, for example, it can be seen that (while the latch member 120 is in its latched position as shown) the lower peripheral portion of the latch member 120 that defines the opening 121 of the latch member 120 projects into a lower portion of the interior space 112 of the coupling body 110. It is that lower peripheral portion of the latch member 120 (and only that portion of the latch member 120) that projects within the latch groove 209 of the male fluid coupling 200 (e.g., see FIG. 1) to hold the female fluid coupling 100 and the male fluid coupling 200 in their coupled/operative arrangement. However, when a user depresses the latch member 120 farther into the coupling body 110 (to the unlatched position of the latch member 120), then the lower peripheral portion of the latch member 120 that defines the opening 121 of the latch member 120 moves downward and out of the lower portion of the interior space 112 of the coupling body 110 (and out of the latch groove 209). In that way, the male fluid coupling 200 can be unlatched/uncoupled from the female fluid coupling 100 by a user's actions of depressing the latch member 120 relative to the coupling body 110. The latch member 120 can rebound from its unlatched position to its latched position because of a biasing force, such as a spring force that acts between the latch member 120 and the coupling body 110 to bias the latch member 120 toward the latched position.

FIG. 9-13 show the fluid coupling system 10 with the female fluid coupling 100 in the coupled/operative arrangement with the male fluid coupling 200. The latch member 120 is in its latched position. The lower peripheral portion of the latch member 120 (i.e., the engagement surface 122) of the female fluid coupling 100 is in contact with the backside of the annular shoulder 208 of the male fluid coupling 200 to hold the female fluid coupling 100 in the coupled/operative arrangement with the male fluid coupling 200.

FIG. 11 is a vertical cross-sectional view that shows the lower-most central engagement surface portion 122a in direct contact with the backside of the annular shoulder 208 of the male fluid coupling 200 to hold the female fluid coupling 100 in the coupled/operative arrangement with the male fluid coupling 200.

FIG. 12 is a horizontal cross-sectional view that shows (within the dotted line ovals) the two lateral engagement surface portions 122b1 and 122b2 of the latch member 120 that are spaced apart from the backside of the annular shoulder 208 of the male fluid coupling 200. That is, the two lateral engagement surface portions 122b1 and 122b2 of the latch member 120 are out of contact with the annular shoulder 208 of the male fluid coupling 200.

FIG. 13 is another cross-sectional view that shows (within the dotted line oval) the lateral engagement surface portion 122b1 of the latch member 120 that is spaced apart from the backside of the annular shoulder 208 of the male fluid coupling 200.

FIGS. 12 and 13 show the arrangement of the female fluid coupling 100 and the male fluid coupling 200 while their axes 102 and 202 are colinear. However, in some cases a side load may be applied to one (or both) of the female fluid coupling 100 or the male fluid coupling 200 (as exemplified by the arcuate dotted line 301 in FIG. 12). In such a scenario, the central longitudinal axes 102 and 202 may become no longer colinear.

Moreover, while such a side load is being applied, in some cases a relative rotational force (e.g., torque) about the central longitudinal axis of the either the female fluid coupling 100 or the male fluid coupling 200 may also be applied. In other words, in some cases a relative side load and a relative torque may applied concurrently. In that scenario, the arrangement of the two lateral engagement surface portions 122b1 and 122b2 of the latch member 120 being spaced apart from the backside of the annular shoulder 208 of the male fluid coupling 200 can resist unlatching.

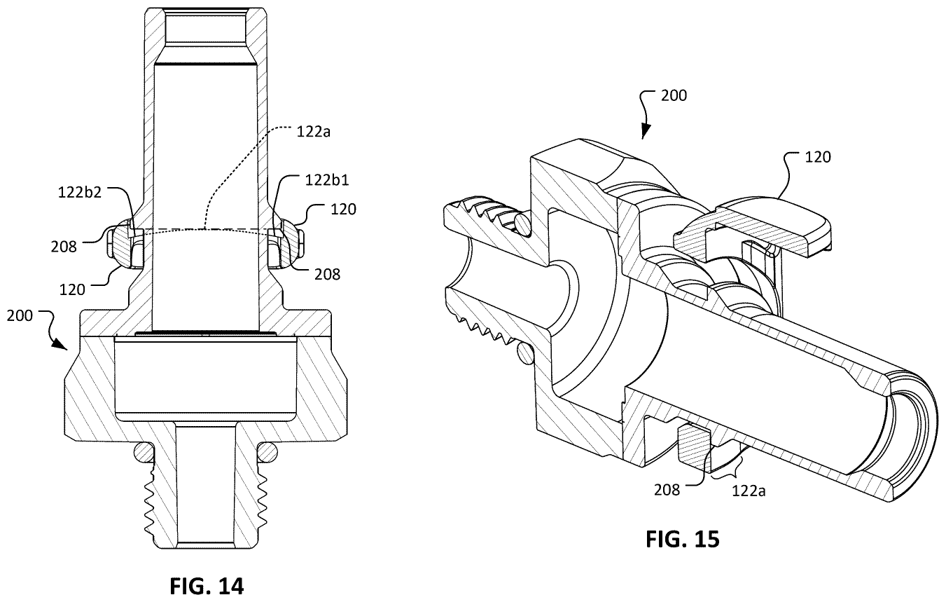

FIGS. 14 and 15 provide additional views of the engagement surface 122 of the latch member 120 in relation to the male fluid coupling 200 and its annular shoulder 208.

As shown in FIG. 14, the backside of the annular shoulder 208 is in contact with the lower-most central engagement surface portion 122a, while the backside of the annular shoulder 208 is spaced apart from the two lateral engagement surface portions 122b1 and 122b2. That arrangement allows for some side loading (and some resulting displacement/movement) without creating contact/friction between the latch member 120 and the annular shoulder 208.

FIG. 15 illustrates an embodiment of the latch member 120 in which the lower-most central engagement surface portion 122a is a planar area that is in contact with the backside of the annular shoulder 208. The two lateral engagement surface portions 122b1 and 122b2 (not visible) are out of contact with the backside of the annular shoulder 208. The two lateral engagement surface portions 122b1 and 122b2 may be planar (while not being coplanar with the lower-most central engagement surface portion 122a) or may be contoured.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment in part or in whole. Conversely, certain features that are described in the context of a single embodiment can also be implemented in multiple embodiments separately or in any suitable subcombination.

Moreover, although features may be described herein as acting in certain combinations and/or initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Although a number of implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A female fluid coupling, comprising:
a coupling body defining a central longitudinal axis and an interior space, wherein the female fluid coupling is configured to receive, in a mated configuration, a front-end portion of a male fluid coupling when the front-end portion is inserted through an open front-end of the coupling body that leads to the interior space; and
a latch member movably coupled to the coupling body and comprising an engagement surface configured to engage against the male fluid coupling to releasably retain the male and female fluid couplings in the mated configuration, the latch member being transversely movable relative to the central longitudinal axis between: (i) a latched position and (ii) an unlatched position,
wherein the engagement surface is closer to the central longitudinal axis in the latched position than in the unlatched position, and
wherein the engagement surface is nonplanar.

2. The female fluid coupling of claim 1, wherein the engagement surface comprises one or more contoured surfaces.

3. The female fluid coupling of claim 1, wherein the engagement surface comprises one or more planar surfaces.

4. The female fluid coupling of claim 1, wherein the engagement surface comprises multiple planar surfaces.

5. The female fluid coupling of claim 1, wherein an edge profile of the engagement surface is at least partially arcuate.

6. The female fluid coupling of claim 1, wherein an edge profile of the engagement surface is fully arcuate.

7. The female fluid coupling of claim 1, wherein the latch member is forcibly biased to the latched position.

8. The female fluid coupling of claim 1, wherein the latch member comprises an upper surface that a user can press to move the latch member from the latched position to the unlatched position.

9. The female fluid coupling of claim 1, wherein the latch member defines an opening through which the front-end portion of the male fluid coupling extends when the male and female fluid couplings are in the mated configuration.

10. The female fluid coupling of claim 9, wherein the opening is an oblong shape.

11. The female fluid coupling of claim 10, wherein the engagement surface extends along less than half of a peripheral wall that defines the oblong shape.

12. The female fluid coupling of claim 11, wherein the engagement surface extends along a backside of the peripheral wall that defines the oblong shape.

13. A fluid coupling system, comprising:
a male fluid coupling comprising:
a front-end portion; and
an annular shoulder projecting radially outward from the front-end portion and defining a latch groove behind the annular shoulder; and
a female fluid coupling comprising:
a coupling body defining a central longitudinal axis and an interior space, wherein the female fluid coupling is configured to receive, in a mated configuration, the front-end portion of the male fluid coupling when the front-end portion is inserted through an open front-end of the coupling body that leads to the interior space; and
a latch member movably coupled to the coupling body and comprising an engagement surface configured to engage within the latch groove and against the annular shoulder of the male fluid coupling to releasably retain the male and female fluid couplings in the mated configuration, the latch member being transversely movable relative to the central longitudinal axis between: (i) a latched position and (ii) an unlatched position,
wherein the engagement surface is closer to the central longitudinal axis in the latched position than in the unlatched position, and wherein the engagement surface is nonplanar.

14. The fluid coupling system of claim 13, wherein the engagement surface comprises one or more contoured surfaces.

15. The fluid coupling system of claim 13, wherein the engagement surface comprises one or more planar surfaces.

16. The fluid coupling system of claim 13, wherein the engagement surface comprises multiple planar surfaces.

17. The fluid coupling system of claim 13, wherein an edge profile of the engagement surface is at least partially arcuate.

18. The fluid coupling system of claim 13, wherein an edge profile of the engagement surface is fully arcuate.

19. The fluid coupling system of claim 13, wherein the latch member is forcibly biased to the latched position.

20. The fluid coupling system of claim 13, wherein the latch member defines an opening through which the front-end portion of the male fluid coupling extends when the male and female fluid couplings are in the mated configuration, wherein the opening is an oblong shape, wherein the engagement surface extends along less than half of a peripheral wall that defines the oblong shape and wherein the engagement surface extends along a backside of the peripheral wall that defines the oblong shape.
